(19) United States
(12) Patent Application Publication
(10) Pub. No.: US 2017/0175808 A1
(43) Pub. Date: Jun. 22, 2017

(54) MULTI-PIECE JOURNAL BEARING

(71) Applicant: BorgWarner Inc., Auburn Hills, MI (US)

(72) Inventors: Daniel Pruitt, BOILING SPRINGS, SC (US); EVAN LUCAS, ASHEVILLE, NC (US); DAVID PRATER, ARDEN, NC (US)

(21) Appl. No.: 15/302,033

(22) PCT Filed: Apr. 1, 2015
(86) PCT No.: PCT/US2015/023768

§ 371 Date: Oct. 5, 2016

Related U.S. Application Data
(60) Provisional application No. 61/978,359, filed on Apr. 11, 2014.

(51) Int. Cl. F16C 17/26; F01D 5/04; F01D 25/16; F02B 33/40; F04D 29/056; F04D 29/053; F02B 37/00; F16C 17/03; F04D 29/28

(52) U.S. Cl. CPC F16C 17/26; F16C 17/035; F01D 5/04; F01D 25/162; F04D 29/284; F04D 29/056; F04D 29/053; F02B 37/00; F02B 33/40; F16C 2360/24; F05D 2220/40; F05D 2240/54; F05D 2240/60

(57) ABSTRACT

A two-piece tilting pad journal bearing (50a) is used to support a rotating assembly of a turbocharger (1). The tilting pad journal bearing (50a) includes a hollow, cylindrical bearing shell (52), and a bearing liner (72) disposed within the bearing shell (52). The bearing liner (72) includes a center portion (74), bearing pads (100), and an axially-extending arm (86) that connects each bearing pad (100) to the center portion (74).

### CROSS-REFERENCE TO RELATED APPLICATIONS

This application claims priority to and all the benefits of U.S. Provisional Application No. 61/978,359, filed on Apr. 11, 2014, and entitled “Multi-Piece Journal Bearing,” which is incorporated herein by reference.

### FIELD OF THE INVENTION

The invention relates to a turbocharger with an improved journal bearing that includes a shell and a liner disposed concentrically within the shell, the liner including bearing pads.

### BACKGROUND

An exhaust gas turbocharger is a type of forced induction system in which engine exhaust gases drive a turbine wheel. The turbine wheel is connected via a shaft to a compressor impeller. Ambient air is compressed by the compressor impeller and is fed into the intake manifold of the engine, allowing the engine to combust more fuel, and thus to produce more power for a given displacement. Considering the volumetric gas intake requirements of an engine operating at peak performance and the comparatively small size of a turbocharger, it can be appreciated that a turbocharger may be expected to rotate at speeds of 300,000 rpm or higher. In addition, the engine exhaust gas that drives the turbine wheel may have a temperature as high as 1,300 F. Thus, turbochargers generally operate at extremely high rotational speeds, and under conditions of high temperature and varying load.

The shaft is supported by a bearing system that includes two spaced-apart journal bearings, which function to stabilize the shaft and dampen oscillations. The bearing system is lubricated and cooled using a lubrication system in which a fluid such as oil is channeled through the bearing system for removal of heat.

### SUMMARY

In some aspects, a journal bearing includes a hollow, cylindrical bearing shell, and a bearing liner disposed in the bearing shell so that an outer surface of the bearing liner is radially spaced apart from an inner surface of the bearing shell. The bearing liner includes a hollow cylindrical center portion, the center portion having a center portion first end and a center portion second end that is opposed to the center portion first end. The bearing liner includes arms that extend axially outward from each of the center portion first end and the center portion second end, each arm including a proximal end that is connected to the center portion, and a distal end opposed to the proximal end. The bearing liner also includes a bearing pad disposed on the distal end of each arm.

The journal bearing may include one or more of the following features: The journal bearing is an assembly of two separate pieces such that the bearing shell is a first piece of the two pieces, and the bearing liner is a second piece of the two pieces. Each arm includes an arm axis that extends between the proximal end and the distal end, and the arms are configured to elastically twist about the arm axis. Each arm includes an arm axis that extends between the proximal end and the distal end, and the arms are configured to elastically bend about an axis perpendicular to the arm axis. Each arm is cantilevered from the center portion. The bearing pad is non-uniform in thickness along a circumferential direction. The bearing pad is shaped so that the circumferential center of the bearing pad is thick relative to a leading end and a trailing end of the bearing pad. The bearing pad is shaped so that a bearing pad outer surface includes a radially extending protrusion. Each bearing pad comprises a circumferential dimension that is greater than a circumferential dimension of the corresponding arm. The journal bearing includes an anti-rotation feature that prevents motion of the bearing liner relative to the bearing shell. The anti-rotation feature comprises a flat surface formed on an inner surface of the bearing shell that cooperatively engages a corresponding flat surface formed on an outer surface of the bearing liner.

In some aspects, a turbocharger includes a turbine section including a turbine wheel; a compressor section including a compressor impeller; a bearing housing including a bore and a shaft disposed in the bore, the shaft connecting the turbine wheel to the compressor impeller, and a tilting pad journal bearing disposed in the bore. The tilting pad journal bearing supports the shaft for rotation relative to the bearing housing, and includes a hollow, cylindrical bearing shell, and a bearing liner disposed within the bearing shell, wherein the bearing liner includes a center portion, bearing pads, and an axially-extending arm that connects each bearing pad to the center portion.

The turbocharger may include one or more of the following features: Each support arm includes a proximal end connected to the center portion, and a distal end opposed to the proximal end, wherein one of the bearing pads is connected to the distal end, and the bearing liner is configured to permit rotation of the support arm about an arm axis that extends between the proximal and distal ends. The bearing pads are non-uniform in thickness along a circumferential direction. The turbocharger includes an anti-rotation feature that prevents motion of the bearing liner relative to the bearing shell.

Journal bearings, sometimes called hydrodynamic bearings or hydrodynamic fluid film bearings, are widely used to support rotating shafts. Journal bearings include a bearing pad, and are used in combination with a pressurized fluid. The pressurized fluid creates a film between the rotating shaft and the bearing pad that allows smooth rotation of the shaft without significant friction losses. The bearing pad may be as simple as a tube that fits concentrically about the rotating shaft, or may be as complicated as a series of bearing pads that are each independently supported on an inner surface of a tubular bearing shell. The latter bearing pads are often referred to as tilting pad bearings.

In some aspects, a tilting pad journal bearing is a two-piece structure that includes a bearing shell and a liner disposed coaxially within the bearing shell. The liner includes bearing pads that are supported on axially-extending arms. This can be compared to some conventional tilting pad bearings that include bearing pads supported on arms that extend radially. The axially-extending arms are configured to bend and/or twist, whereby the bearing pads provide the rotating shaft with radial and pivotal flexure support. As the loading of the rotating shaft changes during operation, the bearing pads deflect relative to the bearing shell inner surface, changing the fluid flow and optimizing the load distribution on the bearing pads and the shaft. The shape and dimensions of the arms may be tuned to change their stiffness characteristics.

In some aspects, the bearing liner is formed as a separate element from the bearing shell, and then is assembled with the bearing shell to form the tilting pad journal bearing. By forming the bearing liner as a separate element, machining of the relatively complex shape that includes an annular center portion, axially extending arms cantilevered from the center portion, and bearing pads disposed on the free ends of the arms, becomes easy and inexpensive relative to some one-piece tilting pad journal bearings such as those formed by an electrical discharge machining (EDM) process.

### BRIEF DESCRIPTION OF DRAWINGS

FIG. 1 is a cross-sectional view of an exhaust gas turbocharger including a pair of tilting pad journal bearings.

FIG. 2 is a perspective view of a two-piece tilting pad journal bearing including a bearing shell and a bearing liner disposed in the shell.

FIG. 3 is a perspective view of the bearing shell of FIG. 2.

FIG. 4 is a perspective view of the bearing liner of FIG. 2.

FIG. 5 is a side cross-sectional view of the journal bearing of FIG. 2.

FIGS. 6-9 illustrate exemplary cross-sectional views of the arm as seen along line 6-6 of FIG. 10.

FIGS. 10-18 illustrate exemplary profiles of the bearing pad as seen in top plan view.

FIGS. 19-20 illustrate exemplary cross-sectional views of the bearing pad as seen along line 19-19 of FIG. 10.

FIG. 21 is a schematic view of a portion of the turbocharger bearing housing.

FIG. 22 is a cross-sectional view of a portion of the turbocharger bearing housing as seen along line 22-22 of FIG. 21.

FIG. 23 is a perspective view of an alternative tilting pad journal bearing.

FIG. 24 is a perspective cross-sectional view of the tilting pad journal bearing of FIG. 23 as seen along line 24-24 of FIG. 25.

FIG. 25 is an end cross-sectional view of the tilting pad journal bearing of FIG. 23.

FIG. 26 is a cross-sectional view of the tilting pad journal bearing of FIG. 23 as seen along line 26-26 of FIG. 25.

FIG. 27 is a side cross sectional view of the bearing shell of the tilting pad journal bearing of FIG. 23.

FIG. 28 is an end view of the bearing shell of the tilting pad journal bearing of FIG. 23.

FIG. 29 is a perspective view of the bearing lining of the tilting pad journal bearing of FIG. 23.

FIG. 30 is a side view of the bearing lining of the tilting pad journal bearing of FIG. 23.

FIG. 31 is an end view of the bearing lining of the tilting pad journal bearing of FIG. 23.

FIG. 32 is a cross-sectional view of the bearing lining of the tilting pad journal bearing of FIG. 23 as seen along line 32-32 of FIG. 30.

FIG. 33 is a perspective view of another alternative tilting pad journal bearing.

FIG. 34 is a perspective cross-sectional view of the tilting pad journal bearing of FIG. 33.

FIG. 35 is an end view of the tilting pad journal bearing of FIG. 33.

FIG. 36 is a perspective view of the bearing shell of the tilting pad journal bearing of FIG. 33.

FIG. 37 is a side cross sectional view of the bearing shell of the tilting pad journal bearing of FIG. 33.

FIG. 38 is side view of the bearing liner of the tilting pad journal bearing of FIG. 33.

FIG. 39 is a perspective view of the bearing liner of the tilting pad journal bearing of FIG. 33.

FIG. 40 is an end view of the bearing liner of the tilting pad journal bearing of FIG. 33.

FIG. 41 is a side cross-sectional view of an alternative bearing shell.

FIG. 42 is a perspective view of a portion of an alternative bearing liner.

FIG. 43 is a schematic perspective view of an alternative bearing assembly.

FIG. 44 is a cross-sectional view of the bearing assembly of FIG. 43 as seen at plane P1 of FIG. 43.

FIG. 45 is a cross-sectional view of the bearing assembly of FIG. 43 as seen at plane P2 of FIG. 43.

FIG. 46 is a side cross-sectional view of an alternative bearing shell including grooves formed on an inner surface thereof.

### DETAILED DESCRIPTION

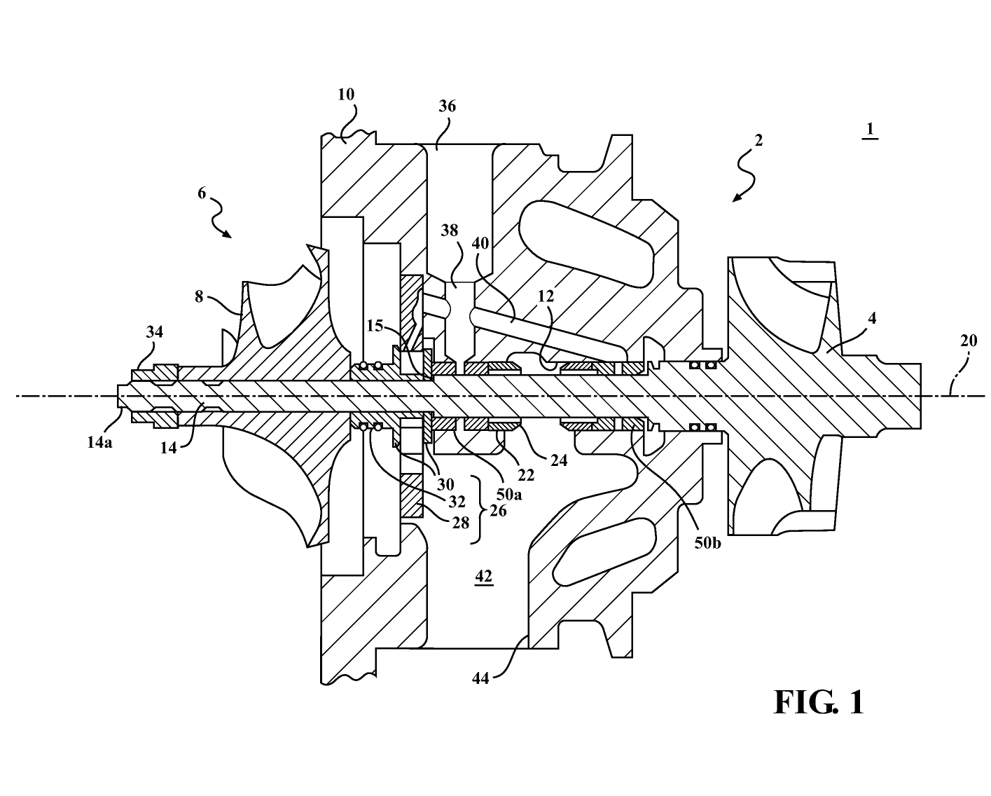

Referring to FIG. 1, an exhaust gas turbocharger 1 includes a turbine section 2, a compressor section 6, and a center bearing housing 10 disposed between, and connecting, the compressor section 6 to the turbine section 2. The turbine section 2 includes a turbine housing (not shown) and a turbine wheel 4 disposed in the turbine housing. The compressor section 6 includes a compressor housing (not shown) and a compressor impeller 8 disposed in the compressor housing. The turbine wheel 4 is connected to the compressor impeller 8 via a shaft 14.

The shaft 14 is supported for rotation about a rotational axis 20 within in a bore 12 formed in the bearing housing 10 via a pair of axially-spaced tilting pad journal bearings 50a, 50b. For example, a compressor-side journal bearing 50a supports the shaft 14 adjacent the compressor section 6, and a turbine-side journal bearing 50b supports the shaft 14 adjacent to the turbine section 2. The journal bearings 50a, 50b are floating ring bearings which employ an inner oil film and an outer oil film to reduce noise (i.e., unbalance whistle and constant tone induced by rotor unbalance and inner oil whirl in the bearing) and rotor amplitude at resonant frequencies. The inner oil film functions to carry the shaft 14 against the external forces acting on the shaft 14, whereas the outer oil film, which is thick relative to the inner oil film, provides the shaft 14 with a large damping coefficient to reduce shaft deflection at resonances and suppress noise.

The axial spacing between the compressor-side journal bearing 50a and the turbine-side journal bearing 50b is maintained by cylindrical a journal bearing spacer 22. The bearing spacer 22 is disposed between the journal bearings 50a, 50b for precise axial location and retention of the journal bearings 50a, 50b within the bore 12. In addition, a thrust bearing assembly 26 is disposed in the bearing housing 10 so as to provide axial support for the shaft 14. The shaft 14 is reduced in diameter on the compressor side of the compressor-side journal bearing 50a, and a shoulder 15 is formed at the transition between diameters. The compressor impeller 8 and the thrust bearing assembly 26, including a thrust bearing 28, a thrust washer assembly 30, and an oil flinger 32, are all supported on the shaft 14 in the reduced diameter portion. The terminal end 14a of the shaft 14 extends axially beyond the compressor impeller 8 and includes an external thread. A nut 34 engages the thread, and is tightened sufficiently to clamp the compressor impeller 8 and the thrust bearing assembly 26 against the shoulder 15.

In use, the turbine wheel 4 in the turbine housing is rotatably driven by an inflow of exhaust gas supplied from the exhaust manifold of an engine. Since the shaft 14 connects the turbine wheel 4 to the compressor impeller 8 in the compressor housing, the rotation of the turbine wheel 4 causes rotation of the compressor impeller 8. As the compressor impeller 8 rotates, it increases the air mass flow rate, airflow density and air pressure delivered to the engine's cylinders via an outflow from the compressor section 6, which is connected to the engine's air intake manifold (not shown).

The turbocharger bearing system is lubricated by oil from the engine. The oil is fed under pressure into the bearing housing 10 via an oil supply port 36 to lubricate the bearing surfaces within and about the journal bearings 50a, 50b. More specifically, oil passes through individual bearing supply channels 38, 40 for lubricating the journal bearings 50a, 50b. The supply channels 38, 40 open at generally axially centered positions with respect to the two journal bearings 50a, 50b such that oil flow may occur in both directions axially to lubricate the bearing surfaces. The journal bearings 50a, 50b have axially centered lubricating oil flow bores 64 that receive oil from the respective supply channels 38, 40. Oil flowing over and through the journal bearings 50a, 50b is eventually collected within a bearing housing sump chamber 42 for return circulation through an outlet port 44.

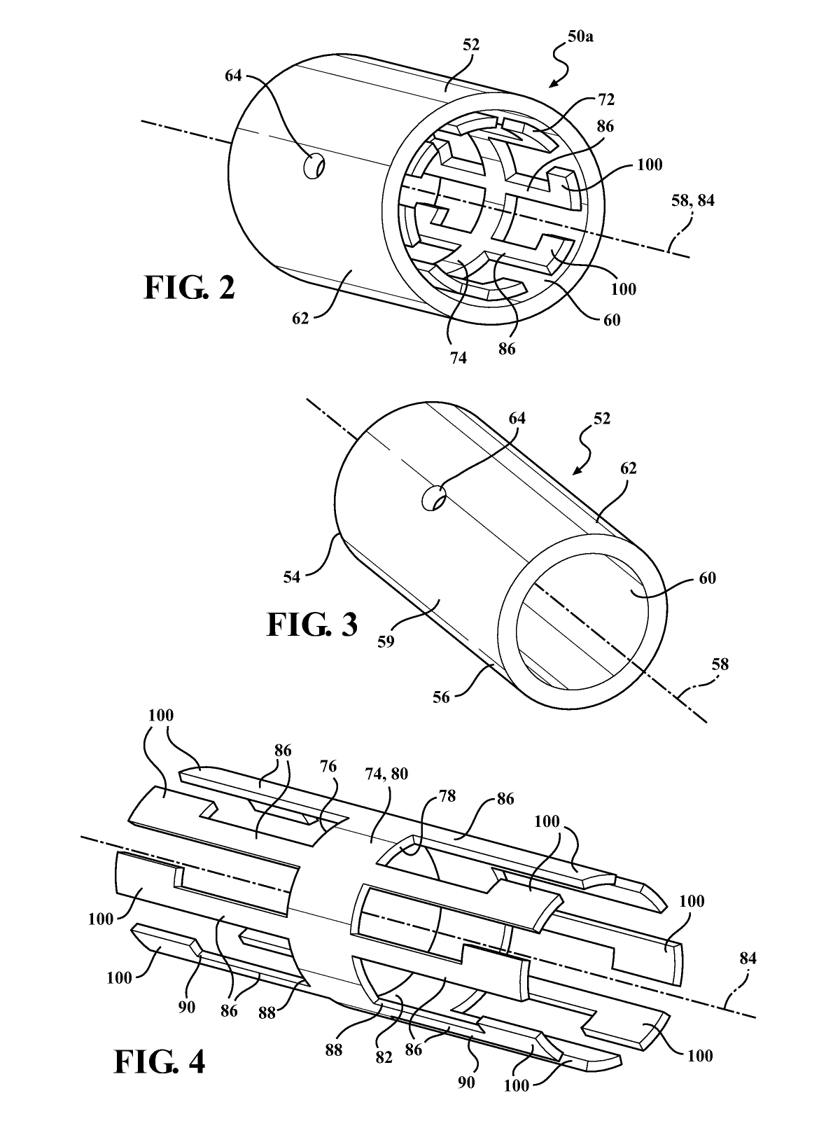

Referring to FIG. 2, the tilting pad journal bearings 50a, 50b are substantially structurally similar, whereby only the compressor-side journal bearing 50a will be described in detail. The tilting pad journal bearing 50a is a two-piece structure that includes a bearing shell 52 and a bearing liner 72 disposed within the bearing shell 52. The bearing liner 72 includes bearing pads 100 that are configured to move (for example, tilt) relative to the bearing shell 52, as discussed further below.

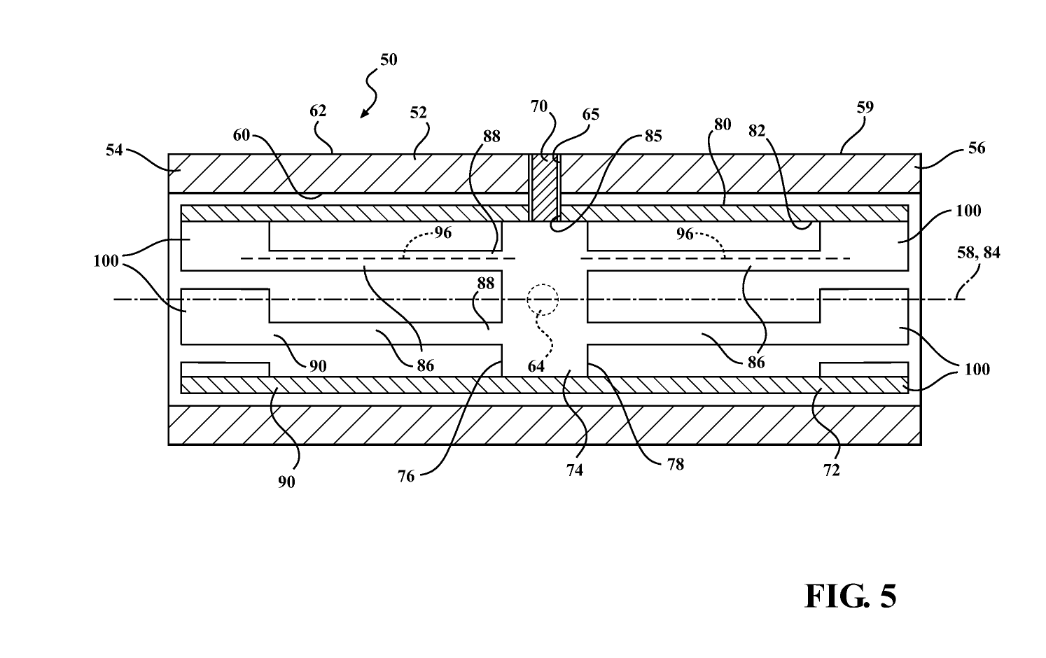

Referring to FIGS. 3 and 5, the bearing shell 52 is generally in the form of a hollow cylinder having a first end 54, and a second end 56 opposed to the first end 54. A bearing shell longitudinal axis 58 extends between the first end 54 and the second end 56. The bearing shell 52 includes an axially-centered oil flow bore 64. The oil flow bore 64 is a radially-extending through opening that permits lubricating oil to flow from an outer surface 62 of the bearing shell 52 to an inner surface 60 thereof. The bearing shell 52 includes a sidewall having a uniform thickness from the bearing shell first end 54 to the bearing shell second end 56. The outer surface 62 defines an outer bearing portion 59 that is shaped and dimensioned to fit with relatively close clearance within a bore 12 formed in the center bearing housing 10, with sufficient gap for the outer oil film. The bearing shell 52 can be formed by various manufacturing techniques utilizing a variety of known bearing materials, such as leaded or unleaded bronze, aluminum, etc.

Referring to FIGS. 4 and 5, the bearing liner 72 includes an annular center portion 74, the bearing pads 100, and arms 86 that connect the bearing pads 100 to the center portion 74. The bearing liner 72 includes an outer surface 80 that faces the inner surface 60 of the bearing shell 52, an inner surface 82 that faces the shaft 14 when in use, and a longitudinal axis 84.

The center portion 74 has an axial dimension that is small relative to the bearing shell axial dimension (e.g., the distance between the bearing shell first end 54 and the bearing shell second end 56). For example, the center portion axial dimension may be about 10 to 35 percent of the bearing shell axial dimension. The center portion 74 has a wall thickness (e.g., the distance between the liner inner surface 82 and the liner outer surface 80) that is less than or equal to the bearing shell wall thickness (e.g., the distance between the bearing shell inner surface 60 and the bearing shell outer surface 62). For example, the center portion wall thickness may be about 30 to 100 percent of the bearing shell wall thickness. The center portion 74 includes a first axial end face 76 and an opposed, second axial end face 78.

The arms 86 extend axially outward from each respective axial end face 76, 78 of the center portion 74 so as to be cantilevered therefrom. Each arm 86 includes a fixed proximal end 88 that is formed integrally (e.g., as a single piece) with the center portion 74, and a free distal end 90 that is opposed to the proximal end 88. Each arm 86 includes an arm longitudinal axis that extends between the respective proximal and distal ends 88, 90. Each arm 86 is axially elongate, and has a generally rectangular shape when viewed in a cross section transverse to the bearing liner longitudinal axis 84. For example, in the cross-sectional view, the circumferential dimension of the arm 86 is greater than the radial dimension of the arm 86. In some embodiments, the term “generally rectangular” refers to being rectilinear, whereas in other embodiments the term “generally rectangular” may refer to having the shape of a sector of an annulus, and thus are slightly arcuate to conform to the curvature of the bearing shell inner surface 60 and of the outer surface of the shaft 14. The axial dimension of the arms 86 is set such that the bearing pads 100 reside within the bearing shell 52 and are positioned adjacent the corresponding bearing shell first or second end 54, 56. The arms 86 are equidistantly spaced apart along a circumference defined by the corresponding axial end face 76, 78.

In the illustrated embodiment, the bearing liner 72 includes eight arms 86 extending from each axial end face 76, 78. However, the number of arms 86 that extend from each respective axial end face 76, 78 is determined by the requirements of the specific application, and may include as few as two arms 86, or as many as twelve arms 86 or more. Each support arm 86 is axially rigid, and has sufficient flexibility and elasticity to permit resilient bending (rotation about an axis transverse to the arm longitudinal axis 96) and/or twisting (rotation about the arm longitudinal axis 96) deflections of the distal end 90 relative to the proximal end 88.

A bearing pad 100 is connected to the distal end 90 of each arm 86, whereby each bearing pad 100 is axially spaced apart from the center portion 74. Each bearing pad 100 has an axial dimension that may be about 10 to 25 percent of the bearing shell axial dimension, and a circumferential dimension that is equal to or greater than a circumferential dimension of the corresponding arm 86. The bearing pad 100 has a wall thickness (e.g., the distance between the liner inner surface 82 and the liner outer surface 80) that corresponds to the thickness of the corresponding arm 86. The bearing pads 100 are equidistantly spaced apart along a circumference of the bearing shell inner surface 60 so that each bearing pad 100 is spaced apart from adjacent bearing pads 100.

The bearing liner 72 can be formed by various manufacturing techniques utilizing a variety of known bearing materials, such as leaded or unleaded bronze, aluminum, etc. For example, in some embodiments, the bearing liner 72 is machined from a cylindrical blank using conventional techniques, and then assembled with the bearing shell 52. Because the bearing liner 72 is formed separately from the bearing shell 52, machining the blank to form the arms 86 and bearing pad 100 is simple and inexpensive relative to manufacture of some single-piece tiling pad journal bearing systems such as, but not limited to, those in which the individual bearing pads are cut from an inner surface using EDM processes. The bearing liner 72 and the bearing shell 52 may be formed of the same material, but are not limited to this configuration.

The bearing liner 72 is disposed coaxially (e.g., concentrically) within the bearing shell 52 such that the bearing liner longitudinal axis 84 is coaxial with the bearing shell longitudinal axis 58, and such that the bearing pads 100 face the bearing shell inner surface 60 adjacent each respective axial end 54, 56 of the bearing shell 52. In addition, each bearing pad 100 is supported by an axially extending arm 86 in a manner such that a vacancy exists between a radially outward-facing (e.g., outer) surface 80 of the bearing pad 100 and a radially inward-facing (e.g., inner) surface 60 of the bearing shell 52. Adjacent each respective bearing shell axial end 54, 56, the bearing pad inner surface 82 defines an inner bearing surface that is shaped and dimensioned to fit with relatively close clearance about the shaft 14 with sufficient gap for the inner oil film. This configuration provides improved control of radial bearing forces.

The axial position and angular orientation of the bearing liner center portion 74 relative to the bearing shell 52 is maintained, for example, by a pin 70 that extends through aligned radial openings 65, 85 provided in the bearing shell 52 and the bearing liner center portion 74 (FIG. 5). Thus, although the tilting pad journal bearing 50 floats within the bore 12, the bearing liner 72 does not float with respect to the bearing shell 52.

Since each support arm 86 is axially rigid, and has sufficient flexibility and elasticity to permit resilient bending and/or twisting deflections of the bearing pad 100 relative to the proximal end 88, as shaft loads change during operation of the turbocharger 1, the bearing pads 100 deflect, changing the lubricating fluid flow and optimizing the load distribution on the bearing pad 100 and shaft 14. In addition, since the arms 86 extend axially, the tilting pad journal bearing 50 provides radial and flexure support of the shaft 14.

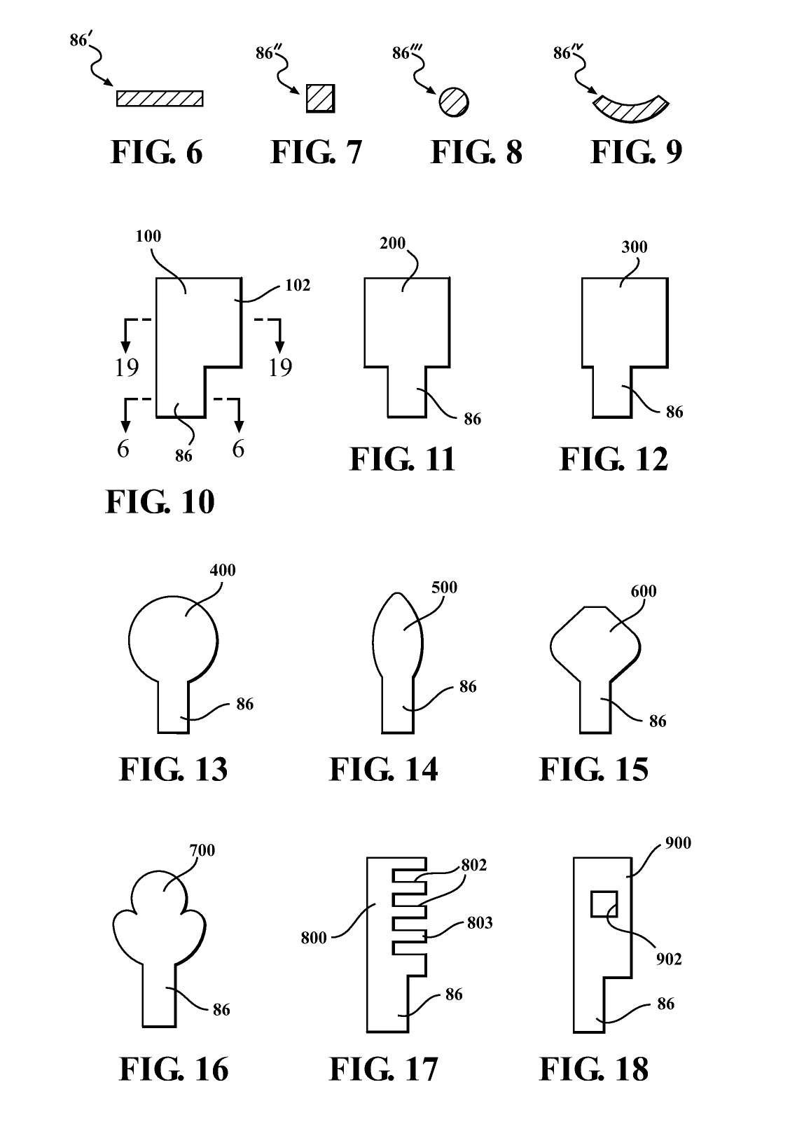

Referring to FIGS. 6-10, the shape and dimensions of the arms 86 may be tuned to change the arm stiffness characteristics in order to accommodate the requirements of a specific application. Several non-limiting exemplary embodiments of the cross-sectional shape of the arms 86 as seen along line 6-6 of FIG. 10 are as follows: rectangular (FIG. 6); square (FIG. 7); circular (FIG. 8); and a sector of an annulus (FIG. 9).

Referring to FIGS. 10-18, the profile of the bearing pads 100 may be tuned to change, for example, the bearing pad stiffness characteristics, the clearance of the bearing pad 100 relative to the inner surface of the bearing shell 52, and the oil flow characteristics in order to accommodate the requirements of a specific application. Several non-limiting exemplary embodiments of the profile of an isolated bearing pad as seen in top plan view will now be described.

Referring to FIG. 10, in some embodiments, the bearing pad 100 has a rectangular profile, and is connected to the arm 86 so as to form a structure that is generally L shaped. The bearing pad 100 is oriented within the bearing shell 52 so that the base 102 of the bearing pad 100 protrudes circumferentially relative to the arm 86 in a direction that is against the direction of bearing rotation.

Referring to FIGS. 11 and 12, in some embodiments, the bearing pad 200, 300 has a rectangular profile, and is connected to the arm 86 so as to form a structure that is generally T shaped. The bearing pad 200, 300 is oriented within the bearing shell 52 so that the bearing pad 200, 300 protrudes circumferentially relative to the arm 86 in both circumferential directions. Although in some embodiments the arm 86 may be centered on the bearing pad 200 (FIG. 11), in other embodiments the arm 86 may not be centered on the bearing pad 300 (FIG. 12).

Referring to FIG. 13, in some embodiments, the bearing pad 400 has a circular profile, and the arm 86 is connected to the bearing pad 400 along a diameter of the bearing pad 400. However, in other embodiments the arm 86 may be connected to the bearing pad 400 along a non-diameter chord of the bearing pad 400 (not shown).

Referring to FIG. 14, in some embodiments, the bearing pad 500 has an oval profile, and the arm 86 is connected to the bearing pad 500 along a long axis of the oval. However, in other embodiments (not shown), the arm 86 may be connected to the bearing pad 500 along a short axis of the oval, or along a chord parallel to, or angled relative to, the long or short axes.

Referring to FIGS. 15-17, in some embodiments, the bearing pad 600, 700, 800 has an irregularly shaped profile. For example, the bearing pad 600 may include both linear and curved peripheral edge portions arranged to form a generally diamond-shaped structure (FIG. 15). In this example, the arm 86 is connected to the bearing pad 600 along an axis of the diamond. However, in other embodiments (not shown), the arm 86 may be connected to the bearing pad 600 along an axis parallel to, or angled relative to, the axes of the diamond. In another example, the bearing pad 700 includes three lobes, and the arm 86 is connected to the bearing pad 700 along an axis of symmetry (FIG. 16). In yet another example, the bearing pad 900 is generally rectangular, and includes circumferentially-aligned slots 802 formed in a leading edge 803 relative to the direction of rotation (FIG. 17).

Referring to FIG. 18, in some embodiments, the bearing pad 900 is generally rectangular in profile, and includes a through opening 902. Although the through opening 902 is illustrated as rectangular, it is not limited to this shape. Although the through opening 902 is illustrated as being generally centered on the bearing pad 900, it is not limited to this location.

Referring to FIGS. 10, 19 and 20, although the cross-sectional shape of the bearing pads 100 is illustrated as having the shape of a sector portion of an annulus, the cross-sectional shape is not limited to this configuration. For example, the cross-sectional shape of the bearing pad 100 may be tuned to change, for example, the bearing pad stiffness characteristics, clearance of the bearing pad 100 relative to the inner surface of the bearing shell 52, and oil flow characteristics in order to accommodate the requirements of a specific application. Two non-limiting exemplary embodiments of the shape of an isolated bearing pad as seen in cross-section along line 19-19 of FIG. 10 will now be described.

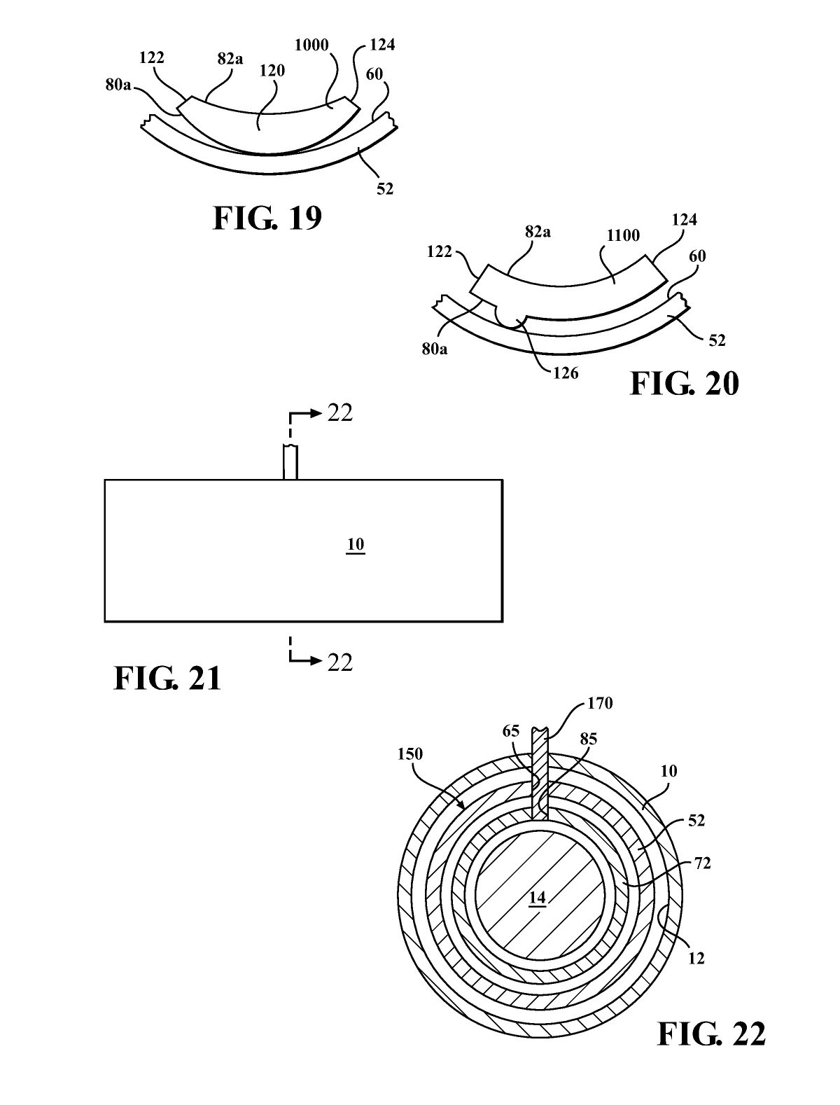

Referring to FIG. 19, in some embodiments, a bearing pad 1000 has an inner surface 82a that is circular to conform to the shape of the outer surface of the shaft 14. In addition, the bearing pad 1000 is non-uniform in thickness along a circumferential direction such that the circumferential center 120 of the bearing pad 1000 is thick relative to the leading and trailing ends 122, 124 of the bearing pad 1000. As a result, the bearing pad outer surface 80a smoothly protrudes radially outward toward the bearing shell inner surface 60.

Referring to FIG. 20, in some embodiments, a bearing pad 1100 has an inner surface 82a that is circular to conform to the shape of the outer surface of the shaft 14. In addition, the bearing pad 1100 includes an outer surface includes a protruding portion (i.e., a ridge) 126 that protrudes radially outward toward the bearing shell inner surface 60. The protruding portion 126 has a semi-circular shape. In the illustrated embodiment, the protruding portion 126 is not centered along a circumference of the bearing pad 1100, and is positioned closer to the leading end 122 of the bearing pad 1100 than the trailing end 124; however, the protruding portion 126 is not limited to this position.

Referring to FIGS. 21 and 22, although the tilting pad journal bearing 50a is a fully floating ring bearing, the turbocharger 1 is not limited to employing fully floating ring bearings. For example, in some embodiments, the turbocharger 1 may employ a tilting pad journal bearing 150 that is a semi-floating ring bearing. The tilting pad journal bearing 150 is similar to the tilting pad journal bearing 50a described above, and like reference numbers refer to common elements. In addition, the tilting pad journal bearing 150 includes an bearing shell anti-rotation feature that prevents rotation of the bearing shell 52 relative to the bore 12. In the illustrated example, the anti-rotation feature is a pin 170 that protrudes from an inner surface of the bore 12, and extends through the through aligned radial openings 65, 85 provided in the bearing shell 52 and the bearing liner center portion 74. In another example (not shown), a detent is formed on an axial end face of the bearing shell 52 that engages the bearing housing 10 to prevent relative rotation between the bearing shell 52 and the bore 12. In this example, the pin 70 is used to maintain the relative positions of the bearing shell 52 and bearing liner 72 as shown in FIG. 5. In yet another example (not shown), an anti-rotation clip may be interposed between the bearing shell 52 and the bore 12. An outer periphery of the clip may be formed having flat regions that register with corresponding flat regions provided on the hearing housing 10, and an inner periphery of the clip may be formed having flat regions that register with corresponding flat regions provided on the bearing shell 52.

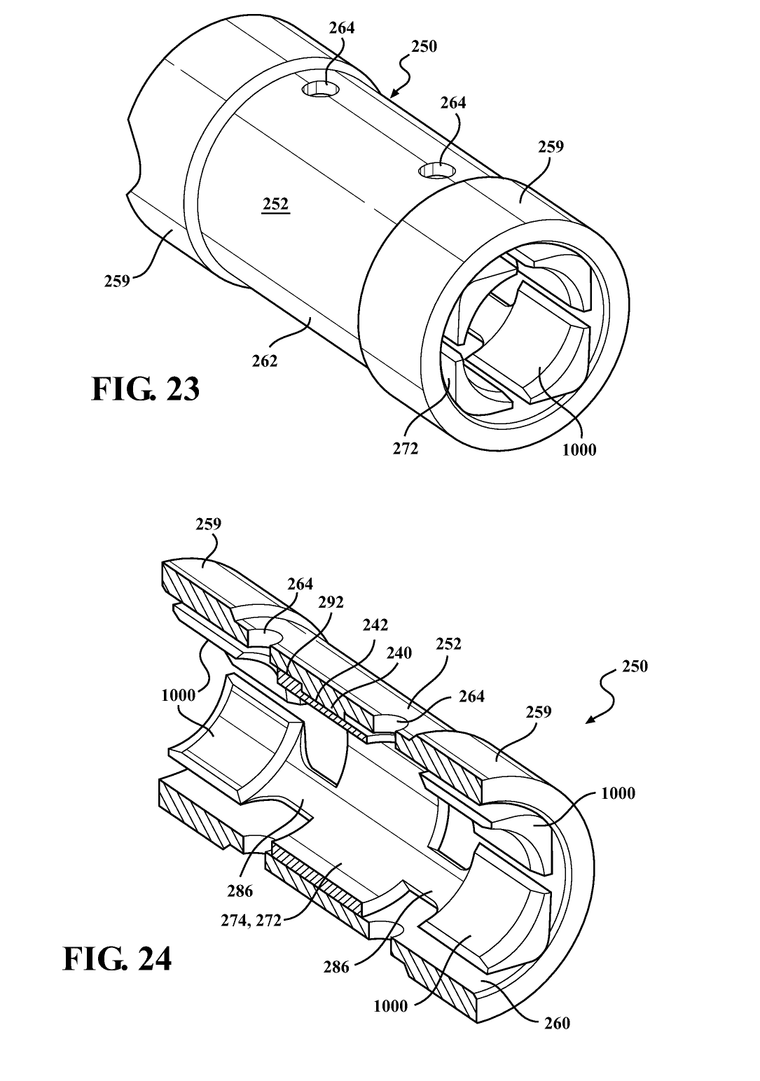

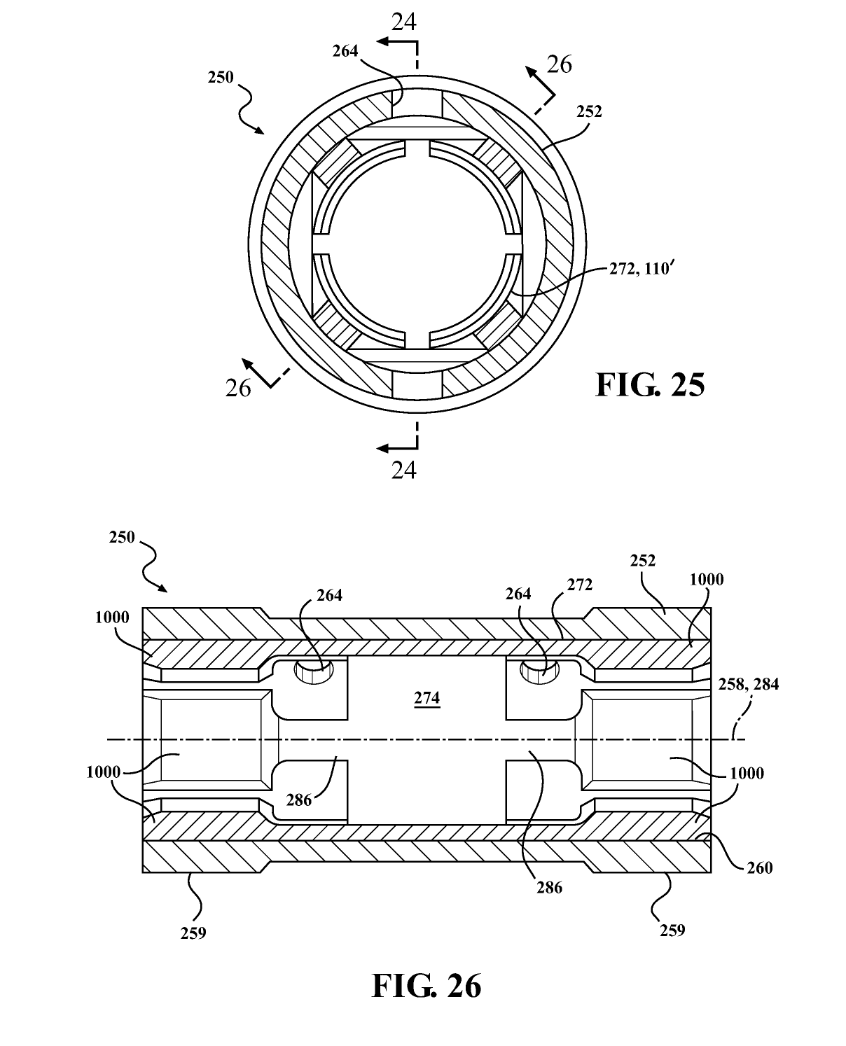

Referring to FIGS. 23-26, an alternative embodiment tilting pad journal bearing 250 is a semi-floating ring bearing. The tilting pad journal bearing 250 is a two-piece structure that includes a bearing shell 252 and a bearing liner 272 disposed within the bearing shell 252. The bearing liner 272 includes bearing pads 1000 that are configured to move (for example, tilt and/or bend) relative to the bearing shell 252, as discussed further below.

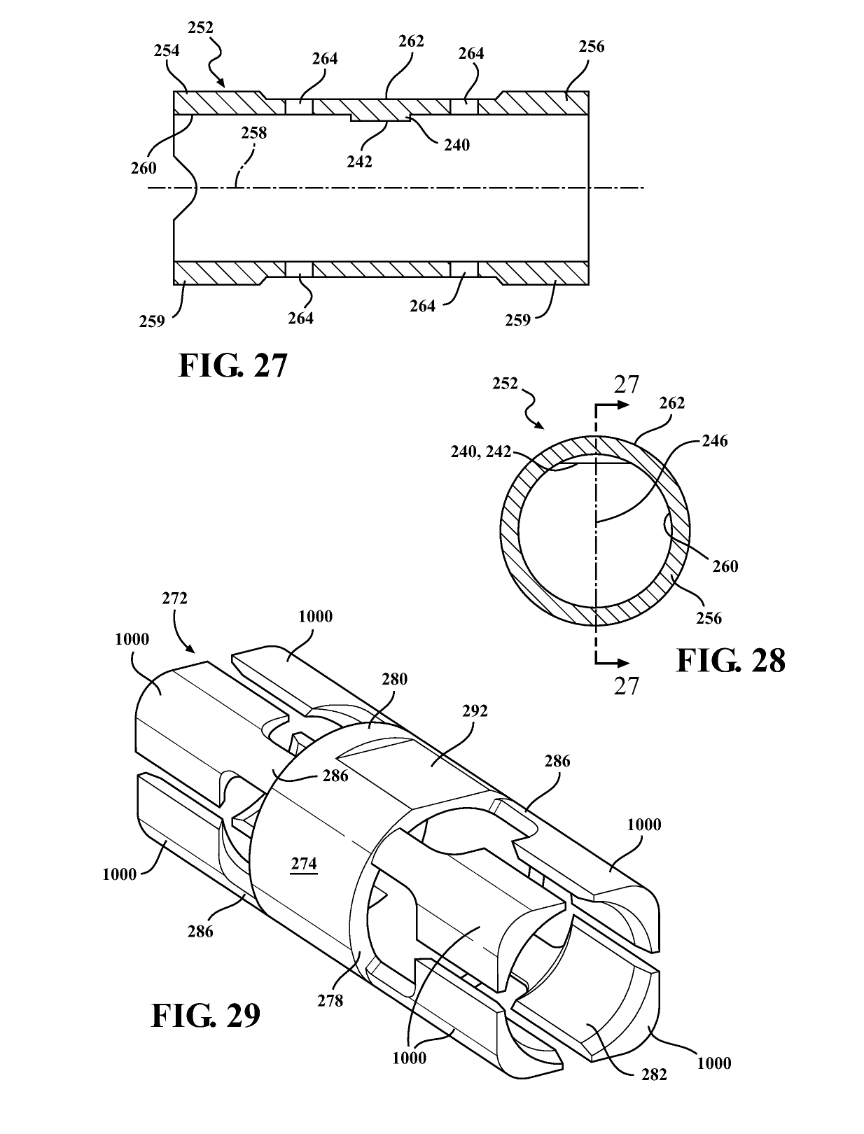

Referring also to FIGS. 27 and 28, the bearing shell 252 is generally in the form of a hollow cylinder having a first end 254, and a second end 256 opposed to the first end 254. A longitudinal axis 258 extends between the first end 254 and the second end 256. A mid-portion of the bearing shell 252 includes several oil flow bores 264 that permit lubricating oil to flow from an outer surface 262 of the bearing shell 252 to an inner surface 260 thereof. The bearing shell inner surface 260 includes a protrusion 240 that extends radially inward and has a flat face 242 (e.g., the shell flat face). The shell flat face 242 is parallel to the bearing longitudinal axis 258 when seen in a side cross-sectional view (FIG. 27), and is perpendicular to an axis 246 that is transverse to the longitudinal axis 258 when seen in an end cross-sectional view (FIG. 28). The shell flat face 242 is an anti-rotation feature and is configured to engage a corresponding liner flat face 292 provided on the outer surface of the bearing liner 272, as discussed further below. The protrusion 240 is positioned mid-way between the bearing shell first end 254 and the bearing shell second end 256.

The outer diameter of the bearing shell 252 is non-uniform. In particular, the shell outer diameter is greater adjacent each axial end 254, 256 relative to the shell mid-portion, whereby the shell outer surface 262 defines an outer bearing portion 259 adjacent to each axial end 254, 256 that is shaped and dimensioned to fit with relatively close clearance within the bearing housing bore 12, with sufficient gap for the outer oil film.

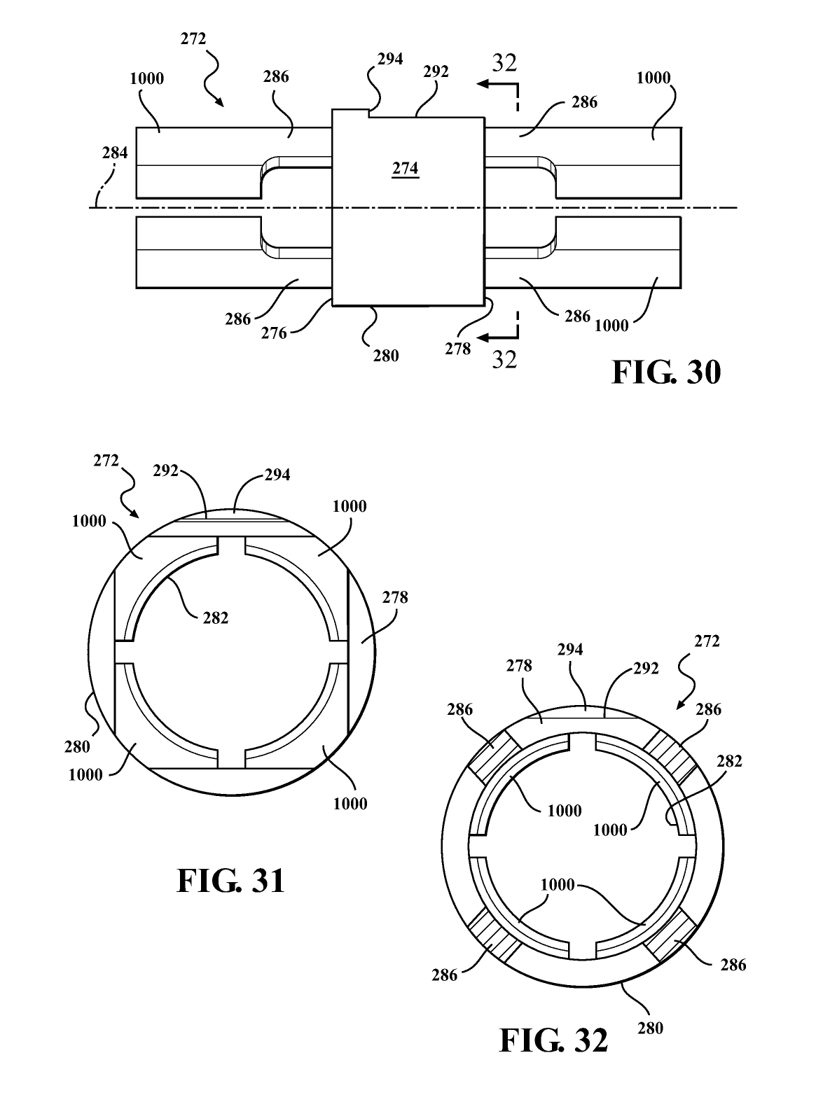

Referring also to FIGS. 29-32, the bearing liner 272 includes an annular center portion 274, the bearing pads 1000, and arms 286 that connect the bearing pads 1000 to the center portion 274. The bearing liner 272 includes an outer surface 280 that faces the inner surface 260 of the bearing shell 252, an inner surface 282 that faces the shaft 14 when in use, and a longitudinal axis 284.

The center portion 274 has an axial dimension that is small relative to the bearing shell axial dimension. For example, the center portion axial dimension may be about 10 to 35 percent of the bearing shell axial dimension. The center portion 274 has a wall thickness that is less than or equal to the bearing shell wall thickness. For example, the center portion wall thickness may be about 30 to 100 percent of the bearing shell wall thickness. The center portion 274 includes a first axial end face 276 and an opposed, second axial end face 278. In addition, the liner flat face 292 is a flat formed on the outer surface 280 of the center portion 274. The liner flat face 292 extends axially from the second axial end face 278 toward the first axial end face 276, and terminates in a shoulder 294 that is disposed closer to the first axial end face 276 than the second axial end face 278.

The arms 286 extend axially outward from each respective axial end face 276, 278 of the center portion 274 so as to be cantilevered therefrom. Each arm 286 includes a fixed proximal end 288 that is formed integrally (e.g., as a single piece) with the center portion 274, and a free distal end 290 that is opposed to the proximal end 288. Each arm 286 is elongate, and has the shape of a sector of an annulus when viewed in a cross section transverse to the bearing liner longitudinal axis 84, and thus are slightly arcuate to conform to the curvature of the bearing shell inner surface 260. The axial dimension of the arms 286 is set such that the bearing pads 1000 reside within the bearing shell 252 and are positioned adjacent the corresponding bearing shell first or second end 254, 256. The arms 286 are equidistantly spaced apart along a circumference defined by the corresponding axial end face 276, 278. In the illustrated embodiment, the bearing liner 272 includes four arms 286 extending from each axial end face 276, 278. Each support arm 286 is axially rigid, and has sufficient flexibility and elasticity to permit resilient bending (rotation about an axis transverse to the bearing liner longitudinal axis 284) and/or twisting (rotation about an axis parallel to the bearing liner longitudinal axis 284) deflections of the distal end 290 relative to the proximal end 288.

The bearing pad 1000 is connected to the distal end 290 of each arm 286, whereby each bearing pad 1000 is axially spaced apart from the center portion 274. In the illustrated embodiment, the bearing pad 1000 has the cross-sectional shape described above with respect to FIG. 19, but is not limited thereto. Each bearing pad 1000 has an axial dimension that may be about 10 to 25 percent of the bearing shell axial dimension, and a circumferential dimension that is greater than a circumferential dimension of the corresponding arm 286. The bearing pad 1000 has a wall thickness (e.g., the distance between the liner inner surface 282 and the liner outer surface 280) that is greater than the thickness of the corresponding arm 286. The bearing pads 1000 are equidistantly spaced apart along a circumference of the bearing shell inner surface 260 so that each bearing pad 1000 is spaced apart from adjacent bearing pads 1000.

The bearing liner 272 is disposed coaxially (e.g., concentrically) within the bearing shell 252 such that the bearing liner longitudinal axis 284 is coaxial with the bearing shell longitudinal axis 258, and such that the bearing pads 1000 face the bearing shell inner surface 260 adjacent each respective axial end 254, 256 of the bearing shell 252. In addition, each bearing pad 1000 is supported by an axially extending arm 286 in a manner such that a vacancy exists between a radially outward-facing surface 280 of the bearing pad 1000 and a radially inward facing surface 260 of the bearing shell 252. Adjacent each respective bearing shell axial end 252, 524, the bearing pad inner surface 282 defines an inner bearing surface that is shaped and dimensioned to fit with relatively close clearance about the shaft 14 with sufficient gap for the inner oil film. This configuration provides improved control of radial bearing forces.

The axial position and angular orientation of the bearing liner center portion 274 relative to the bearing shell 252 is maintained by the cooperative engagement of the shell flat face 242 with the liner flat face 292 (FIG. 24). Thus, although the tilting pad journal bearing 250 floats within the bore 12, the bearing liner 272 does not float with respect to the bearing shell 252.

Since each support arm 286 is axially rigid, and has sufficient flexibility and elasticity to permit resilient bending and/or twisting deflections of the bearing pad 1000 relative to the proximal end 288, as shaft loads change during operation of the turbocharger 1, the bearing pads 1000 deflect, changing the lubricating fluid flow and optimizing the load distribution on the bearing pad 1000 and shaft 14. In addition, since the arms 286 extend axially, the tilting pad journal bearing 250 provides radial and flexure support of the shaft 14.

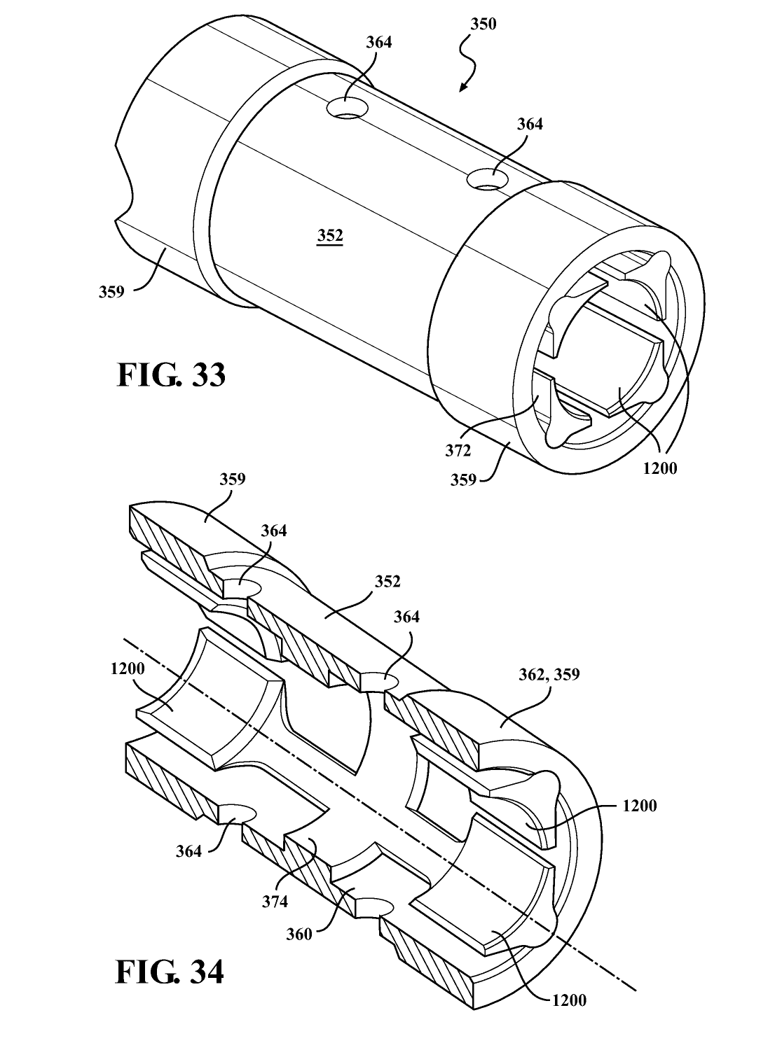

Referring to FIGS. 33-35, another alternative embodiment tilting pad journal bearing 350 is a semi-floating ring bearing. The tilting pad journal bearing 350 is a two-piece structure that includes a bearing shell 352 and a bearing liner 372 disposed within the bearing shell 352. The bearing liner 372 includes bearing pads 1200 that are configured to move (for example, tilt and/or bend) relative to the bearing shell 352, as discussed further below.

Referring also to FIGS. 36 and 37, the bearing shell 352 is generally in the form of a hollow cylinder having a first end 354, and a second end 356 opposed to the first end 354. A longitudinal axis 358 extends between the first end 354 and the second end 356. A mid-portion of the bearing shell 352 includes several oil flow bores 364 that permit lubricating oil to flow from an outer surface 362 of the bearing shell 352 to an inner surface 360 thereof. The bearing shell inner surface 360 includes grooves 340 that extend axially between the first and second ends 354, 356, and are equidistantly spaced apart about a circumference of the bearing shell inner surface 360. The grooves 340 are an anti-rotation feature and are configured to engage a corresponding ridge 392 provided on the outer surface of the bearing liner 372, as discussed further below. Each groove 340 is shaped and dimensioned to correspond to the shape and dimensions of axially extending ridges 392 provided on the bearing liner 372.

The outer diameter of the bearing shell 352 is non-uniform. In particular, the shell outer diameter is greater adjacent each axial end 354, 356 relative to the shell mid-portion, whereby the shell outer surface 362 defines an outer bearing portion 359 adjacent to each axial end 354, 356 that is shaped and dimensioned to fit with relatively close clearance within the bearing housing bore 12, with sufficient gap for the outer oil film.

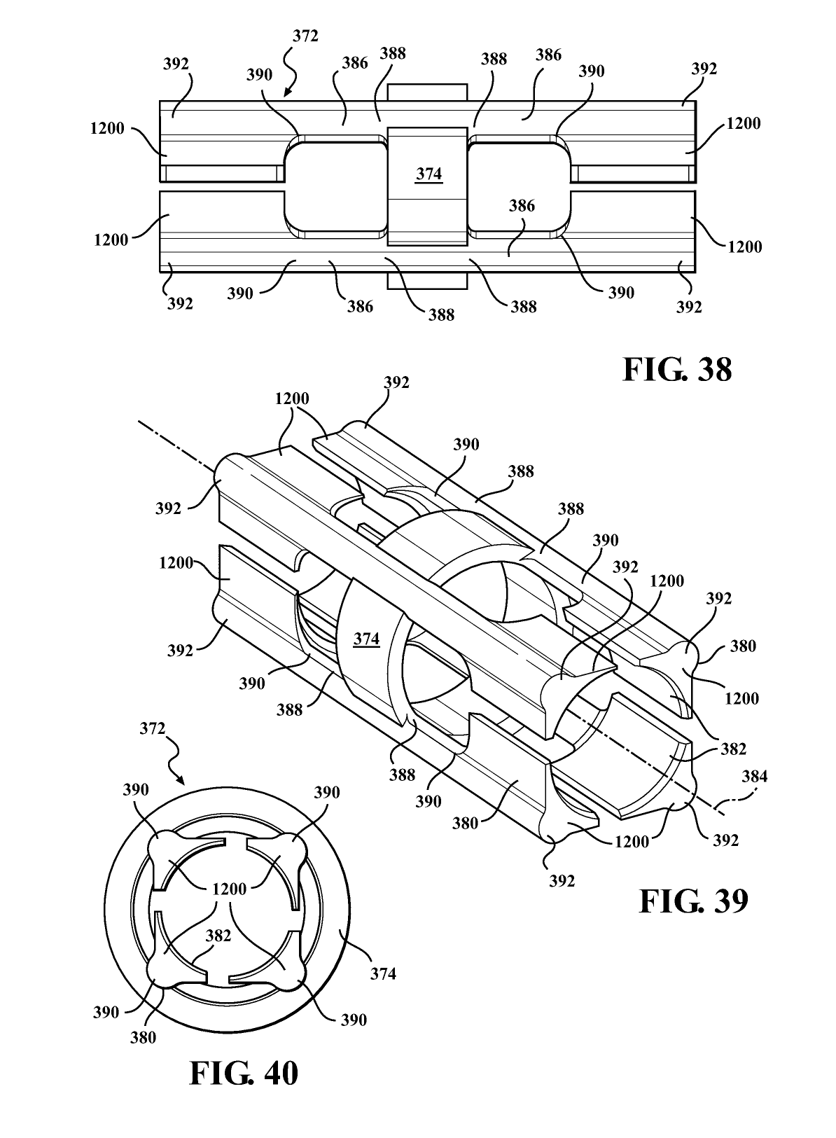

Referring also to FIGS. 38-40, the bearing liner 372 includes an annular center portion 374, the bearing pads 1200, and arms 386 that connect the bearing pads 1200 to the center portion 374. The bearing liner 372 includes an outer surface 380 that faces the inner surface 360 of the bearing shell 352, an inner surface 382 that faces the shaft 14 when in use, and a longitudinal axis 384.

The center portion 374 has an axial dimension that is small relative to the bearing shell axial dimension. For example, the center portion axial dimension may be about 10 to 35 percent of the bearing shell axial dimension. The center portion 374 has a wall thickness that is less than or equal to the bearing shell wall thickness. For example, the center portion wall thickness may be about 30 to 100 percent of the bearing shell wall thickness. The center portion 374 includes a first axial end face 376 and an opposed, second axial end face 378.

The arms 386 extend axially outward from each respective axial end face 376, 378 of the center portion 374 so as to be cantilevered therefrom. Each arm 386 includes a fixed proximal end 388 that is formed integrally (e.g., as a single piece) with the center portion 374, and a free distal end 390 that is opposed to the proximal end 388. Each arm 386 is elongate, and is generally triangular when viewed in a cross section transverse to the bearing liner longitudinal axis 84. The axial dimension of the arms 386 is set such that the bearing pads 1200 reside within the bearing shell 352 and are positioned adjacent the corresponding bearing shell first or second end 354, 356. The arms 386 are equidistantly spaced apart along a circumference defined by the corresponding axial end face 376, 378. In the illustrated embodiment, the bearing liner 372 includes four arms 386 extending from each axial end face 376, 378. Each support arm 386 is axially rigid, and has sufficient flexibility and elasticity to permit resilient bending (rotation about an axis transverse to the bearing liner longitudinal axis 384) and/or twisting (rotation about an axis parallel to the bearing liner longitudinal axis 384) deflections of the distal end 390 relative to the proximal end 388.

The bearing pad 1200 is connected to the distal end 390 of each arm 386, whereby each bearing pad 1200 is axially spaced apart from the center portion 374. Each bearing pad 1200 has an axial dimension that may be about 10 to 25 percent of the bearing shell axial dimension, and a circumferential dimension that is greater than a circumferential dimension of the corresponding arm 386. The bearing pad 1200 has a wall thickness (e.g., the distance between the liner inner surface 382 and the liner outer surface 380) that is greater than the thickness of the corresponding arm 386. The bearing pads 1200 are equidistantly spaced apart along a circumference of the bearing shell inner surface 360 so that each bearing pad 1200 is spaced apart from adjacent bearing pads 1200.

In the illustrated embodiment, the bearing pad 1200 has a cross-sectional shape that is similar to the one described above with respect to FIG. 20. In particular, the bearing pad 1200 has an inner surface 382 that is circular to conform to the shape of the outer surface of the shaft 14. In some embodiments, however, the shape of the bearing pad inner surface 382 does not conform exactly to that of the shape of shaft 14. For example, the radius of the bearing pad inner surface 382 may not be identical to that of the shaft so that the pad 1200 is preloaded.

In addition, the outer surface of the bearing pad 1200 includes a protruding portion (i.e., the ridge) 392 that protrudes radially outward toward the bearing shell inner surface 360. The ridge 392 has a semi-circular shape. In the illustrated embodiment, the ridge 392 is centered along a circumference of the bearing pad 1200, and extends axially along the corresponding arm 386 and the across the center portion 374. Thus, for arms 386 and pads 1200 that are coaxial but on opposed sides of the center portion 374, the corresponding ridges 392 intercept to form a single continuous ridge that extends between opposed axial ends of the bearing liner 372.

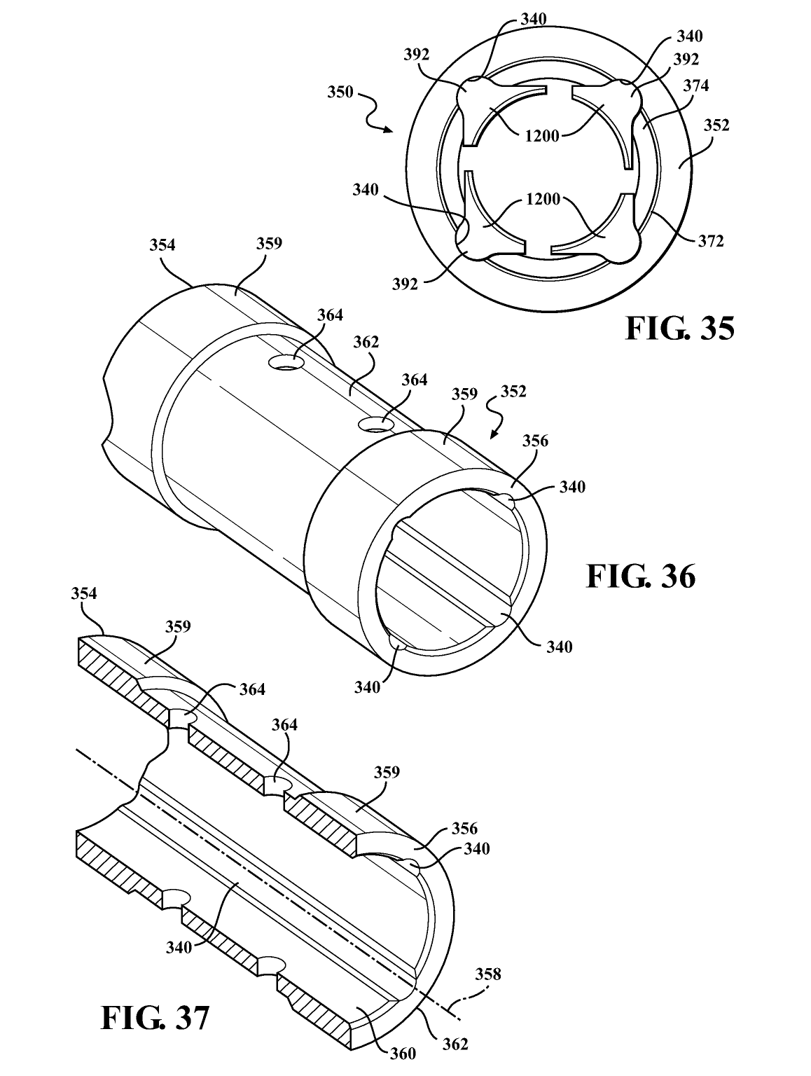

The bearing liner 372 is disposed coaxially (e.g., concentrically) within the bearing shell 352 such that the bearing liner longitudinal axis 384 is coaxial with the bearing shell longitudinal axis 358, the bearing pads 1200 face the bearing shell inner surface 360 adjacent each respective axial end 354, 356 of the bearing shell 352, and each of the bearing liner ridges 392 are received within a corresponding groove 340 of the bearing shell. Each groove 340 provides a bearing surface for the pad 1200 during a twisting motion of pad 1200. Adjacent each respective bearing shell axial end 352, 354, the bearing pad inner surface 382 defines an inner bearing surface that is shaped and dimensioned to fit with relatively close clearance about the shaft 14 with sufficient gap for the inner oil film. This configuration provides improved control of radial bearing forces. The angular orientation of the bearing liner center portion 374 relative to the bearing shell 352 is maintained by the cooperative engagement of the bearing shell grooves 340 with the liner ridges 392 (FIG. 35). In some embodiments, the axial position of the bearing liner center portion 374 relative to the bearing shell 352 is maintained via an anti-rotation device such as a pin or clip. Thus, although the tilting pad journal bearing 350 floats within the bore 12, the bearing liner 372 does not float with respect to the bearing shell 352.

Since each support arm 386 is axially rigid, and has sufficient flexibility and elasticity to permit resilient bending and/or twisting deflections of the bearing pad 1200 relative to the proximal end 388, as shaft loads change during operation of the turbocharger 1, the bearing pads 1200 deflect, changing the lubricating fluid flow and optimizing the load distribution on the bearing pad 1200 and shaft 14. In addition, since the arms 386 extend axially, the tilting pad journal bearing 350 provides radial and flexure support of the shaft 14.

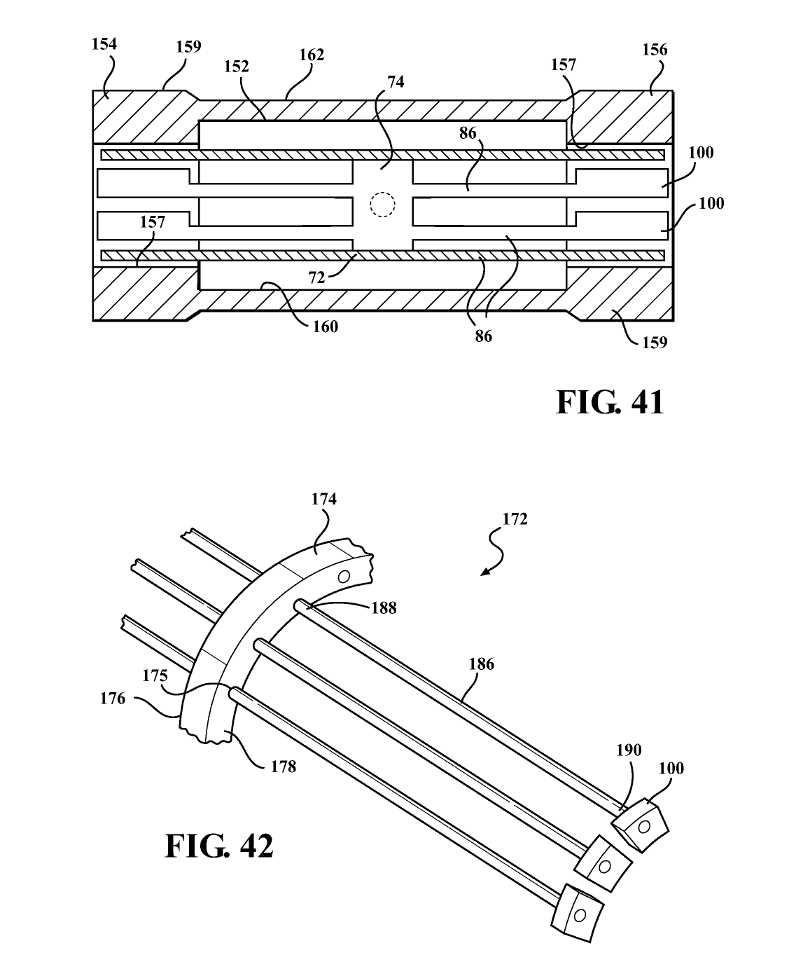

Referring to FIG. 41, although in the embodiment described above with respect to FIGS. 2-5, the bearing shell 52 has a hollow cylindrical shape that includes sidewalls having a uniform thickness from the bearing shell first end 54 to the bearing shell second end 56, the bearing shell 52 is not limited to this configuration. For example, in some embodiments, an alternative bearing shell 152 includes shell sidewalls that are non-uniform in thickness such that the sidewalls are relatively thin in the central portion of the bearing shell 152 relative to the thickness adjacent each axial end 154, 156. In addition, adjacent each axial end 154, 156, the inner surface 160 defines an inner bearing portion 157 that is shaped and dimensioned to fit with relatively close clearance about the shaft 14 with sufficient gap for the inner oil film. Likewise, adjacent each respective axial end 154, 156, the outer surface 162 defines an outer bearing portion 159 that is shaped and dimensioned to fit with relatively close clearance within the bore 12 formed in the center bearing housing 10, with sufficient gap for the outer oil film. The bearing liner 72 is disposed coaxially within the bearing shell 152 such that the bearing pads 100 face the inner bearing portion 157.

Referring to FIG. 42, although in the embodiments described above with respect to FIGS. 2-5 and 29-32, the bearing liner 72, 272 includes the arms 86, 286 that are formed integrally (e.g., as a single piece) with the center portion 74, 274, the bearing liner 72, 272 is not limited to this configuration. For example, an alternative bearing liner 172 includes arms 186 that are formed separately from the center portion 174, and then assembled thereto by inserting the arm proximal ends 188 into corresponding openings 175 formed in the respective center portion axial end faces 176, 178. In some embodiments, the arms 186 are fixed within the openings 175 by conventional means such as press fit, adhesive, or keying. In other embodiments, the arms 186 are configured to rotate within the openings 175.

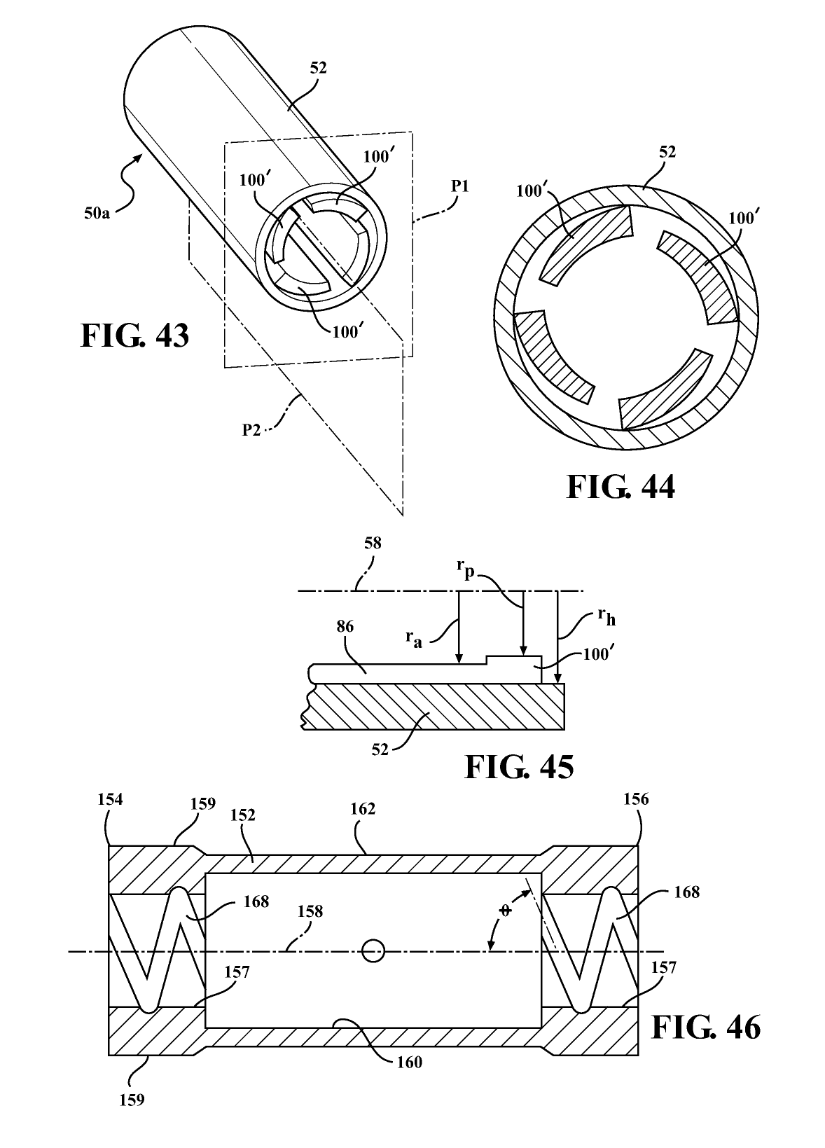

Referring to FIGS. 43-45, although in the embodiment described above with respect to FIGS. 2-5, the arms 86 support the bearing pads 100′ such that, in an unloaded state, the bearing pad outer surface 80a is generally parallel to the bearing shell inner surface 60, the bearing liner 72 is not limited to this configuration. For example, each bearing pad 100′ may be connected to the corresponding arm 86 so as to be angled relative to the bearing shell inner surface 60 in an unloaded state (FIG. 44). In some embodiments, the tilting bearing pad 100′ may further be formed having a wedge shape in cross section so that one edge (e.g., the leading edge or trailing edge with respect to the direction of rotation) of the bearing pad 100′ is closer to the bearing shell 52 than the opposed edge. In some embodiments, the bearing pad 100′ has a thickness (e.g., radial dimension) that is greater than that of the arm 86 (FIG. 45), and is configured to protrude inward relative to the arm 86. For example, the radial dimension rₐ of the arm inner surface 82b is smaller than the radial dimension rₕ of the bearing shell inner surface 60 and greater than the radial dimension rₚ of the bearing pad inner surface 82a.

Referring to FIG. 46, the inner surface 60, 160, 260 of the bearing shell 52, 152, 252 may include at least one lubrication fluid-directing groove 168. The lubrication fluid-directing groove 168 serves to alter oil whirl, whereby subsynchronous vibration of the bearing 50 is reduced, and thus noise is reduced. The lubrication fluid-directing groove(s) 168 may have various shapes and dimensions. For example, one or more lubrication fluid-directing groove 168 may extend along a helical path that is arranged at a helix angle 1 relative to the bearing shell longitudinal axis 58, 158. The helix angle 1 may be selected from an angle in the range of 5 degrees to 85 degrees, and will be determined based on the requirements of the specific application. The groove width and depth will also be determined based on the requirements of the specific application.

Although the bearing pads are described herein as being equidistantly spaced apart along a circumference of the bearing shell inner surface so that each bearing pad is spaced apart from adjacent bearing pads, the bearing pads are not limited to this configuration. For example, in some embodiments, the bearing pads may be non-equidistantly spaced apart along a circumference of the bearing shell inner surface.

Selected illustrative embodiments of multi-piece journal bearings are described above in some detail. It should be understood that only structures considered necessary for clarifying the present invention have been described herein. Other conventional structures, and those of ancillary and auxiliary components of the system, are assumed to be known and understood by those skilled in the art. Moreover, while working examples of multi-piece journal bearings have been described above, the multi-piece journal bearings are not limited to the working examples described above, but various design alterations may be carried out without departing from the present invention as set forth in the claims.

1. A journal bearing comprising:
a hollow, cylindrical bearing shell; and
a bearing liner disposed in the bearing shell so that an outer surface of the bearing liner is radially spaced apart from an inner surface of the bearing shell, wherein the bearing liner includes
a hollow cylindrical center portion, the center portion having a center portion first end and a center portion second end that is opposed to the center portion first end,
arms that extend axially outward from each of the center portion first end and the center portion second end, each arm including a proximal end that is connected to the center portion, and a distal end opposed to the proximal end, and
a bearing pad disposed on the distal end of each arm.

2. The journal bearing of claim 1, wherein the journal bearing is an assembly of two separate pieces such that the bearing shell is a first piece of the two pieces, and the bearing liner is a second piece of the two pieces.

3. The journal bearing of claim 1, wherein each arm includes an arm axis that extends between the proximal end and the distal end, and the arms are configured to elastically twist about the arm axis.

4. The journal bearing of claim 1, wherein each arm includes an arm axis that extends between the proximal end and the distal end, and the arms are configured to elastically bend about an axis perpendicular to the arm axis.

5. The journal bearing of claim 1, wherein each arm is cantilevered from the center portion.

6. The journal bearing of claim 1, wherein the bearing pad is non-uniform in thickness along a circumferential direction.

7. The journal bearing of claim 6, wherein the bearing pad is shaped so that the circumferential center of the bearing pad is thick relative to a leading end and a trailing end of the bearing pad.

8. The journal bearing of claim 6, wherein the bearing pad is shaped so that a bearing pad outer surface includes a radially extending protrusion.

9. The journal bearing of claim 1, wherein each bearing pad comprises a circumferential dimension that is greater than a circumferential dimension of the corresponding arm.

10. The journal bearing of claim 1, including an anti-rotation feature that prevents motion of the bearing liner relative to the bearing shell.

11. The journal bearing of claim 10, wherein the anti-rotation feature comprises a flat surface formed on an inner surface of the bearing shell that cooperatively engages a corresponding flat surface formed on an outer surface of the bearing liner.

12. A turbocharger comprising;
a turbine section including a turbine wheel;
a compressor section including a compressor impeller;
a bearing housing including a bore and a shaft disposed in the bore, the shaft connecting the turbine wheel to the compressor impeller, and
a tilting pad journal bearing disposed in the bore, the tilting pad journal bearing supporting the shaft for rotation relative to the bearing housing, the journal bearing including
a hollow, cylindrical bearing shell, and
a bearing liner disposed within the bearing shell, wherein the bearing liner includes a center portion, bearing pads, and an axially-extending arm that connects each bearing pad to the center portion.

13. The turbocharger of claim 12, wherein
each support arm includes a proximal end connected to the center portion, and a distal end opposed to the proximal end, wherein one of the bearing pads is connected to the distal end, and
the bearing liner is configured to permit rotation of the support arm about an arm axis that extends between the proximal and distal ends.

14. The turbocharger of claim 12, wherein the bearing pads are non-uniform in thickness along a circumferential direction.

15. The turbocharger of claim 12, including an anti-rotation feature that prevents motion of the bearing liner relative to the bearing shell.
